(19) United States
(12) Patent Application Publication
(10) Pub. No.: US 2026/0155319 A1
(43) Pub. Date: Jun. 4, 2026

(54) SWITCHING DEVICE WITH TERMINAL CONTACTS

(71) Applicant: EATON INTELLIGENT POWER LIMITED, Dublin 4 (IE)

(72) Inventors: Varsha Hrishikesh SABALE, Maharashtra (IN); Ralph LINDEN, Cologne (DE); Albert ZACHARIAS, Neuwied (DE); Thomas KONIETZKO, Niederkassel (DE); Bharat NANDAN, Uttar Pradesh (IN); Ashish DAS, ODISHA (IN)

(21) Appl. No.: 19/126,316

(22) PCT Filed: Nov. 20, 2023
(86) PCT No.: PCT/EP2023/025489

§ 371 Date: May 1, 2025

(30) Foreign Application Priority Data
Nov. 22, 2022 (IN) 202211066967
Jan. 5, 2023 (GB) 2300164.7

(51) Int. Cl. H01H 3/26; H01H 1/58

(52) U.S. Cl. CPC H01H 3/26; H01H 1/58

(57) ABSTRACT

Some embodiments relate to a switching device including a first and a second terminal contact, a first fixed contact arranged at the first terminal contact, a second fixed contact arranged at the second terminal contact, a slot motor comprising a first and a second motor part, a contact bridge and a first and a second movable contact arranged at the contact bridge. The first and second terminal contact can include a sandwich structure of at least a first and a second layer. The first layer is made of a non-ferromagnetic material and the second layer is made of a ferromagnetic material. The first and second motor part provide a magnetic field at the first and second fixed contact and at the first and second movable contact.

### CROSS-REFERENCE TO RELATED APPLICATIONS

This application is a national phase filing under 35 C.F.R. § 371 of and claims priority to PCT Patent Application No. PCT/EP2023/025489, filed on Nov. 20, 2023, which claims the benefit of Indian Application No. 202211066967, filed on Nov. 22, 2022, and British Application No. 2300164.7, filed on Jan. 5, 2023, the disclosure of each is hereby incorporated by reference in their entirety.

### DESCRIPTION

The present disclosure is related to a switching device with a first and a second terminal contact.

The switching device is realized as electromechanical switching device. The switching device is configured e.g. to conduct and switch bidirectional AC or DC currents. The switching device is implemented e.g. as circuit breaker. In case the switching device is set from a conducting state to a non-conducting state, an arc is generated. Also in case of short-circuit an electrodynamic lift-off of the contacts results in an arc. The arc has a duration named arcing time.

In order to reduce a melting of the contacts and to safely interrupt a load current flowing through the switching device, the arcing time should be kept short.

It is an object to provide a switching device that reduces an arcing time.

This object is achieved by the subject-matter of the independent claim. Further developments and embodiments are described in the dependent claims.

A switching device is provided which comprises a first and a second terminal contact, a first fixed contact arranged at the first terminal contact, a second fixed contact arranged at the second terminal contact, a contact bridge and a first and a second movable contact arranged at the contact bridge.

In an embodiment of the switching device, the first terminal contact and the second terminal contact comprise a sandwich structure of at least a first and a second layer. The first layer is made of a non-ferromagnetic material and the second layer is made of a ferromagnetic material.

Advantageously, the second layer having ferromagnetic material increases a magnetic field that drives a first arc away from the first fixed contact and the first movable contact and also drives a second arc away from the second fixed contact and the second movable contact. By the increased magnetic field, an arcing time is reduced. The arcing time is the time between generation of an arc and the blow out of the arc.

In an embodiment, the switching device comprises a slot motor comprising a first and a second motor part.

In a further development of the switching device, the first and the second motor part provide magnetic fields at the first and the second fixed contact and at the first and the second movable contact. In an example, the first motor part is configured to provide a magnetic field at the first fixed contact and at the first movable contact in case the first movable contact is in contact to the first fixed contact and in case the first movable contact is in a maximum distance to the first fixed contact. The second motor part is configured to provide a magnetic field at the second fixed contact and at the second movable contact in case the second movable contact is in contact to the second fixed contact and in case the second movable contact is in a maximum distance to the second fixed contact. The maximum distance results e.g. from a short-circuit condition and/or from setting the switching device from an on-state of the switching device into an off-state of the switching device.

Advantageously, the slot motor increases the magnetic field which drives the arcs away from the first and the second fixed contact and the first and the second movable contact.

Thus, the risk of melting of the contacts and the arcing time is reduced.

In an embodiment of the switching device, the non-ferromagnetic material is copper or an alloy of copper, e.g. Cu—PHC or CuAl5. Cu—PHC is the abbreviation for phosphorus-deoxidized high conductive copper; Cu—PHC a very pure copper that has been deoxidized by an addition of phosphorus. CuAl5 is a copper aluminum alloy. Other alloys are possible for fabricating the first layer of the sandwich.

In an embodiment of the switching device, the ferromagnetic material is one of a group consisting of iron, nickel, cobalt, an alloy of iron, nickel or cobalt and an alloy of a rare-earth metal, e.g. DC04; FeNi; FeCoNi; or NdFeB. DC04 is a deep-drawing steel of the DC grade family of steel. FeNi is an iron nickel alloy. FeCoNi is an iron cobalt nickel alloy. NdFeB is also known as neodymium magnet and is an alloy of neodymium, iron and boron. NdFeB is a permanent magnet.

In an example, the first and the second layer form one piece.

In an example, the ferromagnetic material is a magnetically “soft” material or a magnetically “hard” material. The magnetically “soft” material (e.g. annealed iron) can be magnetized but does not tend to stay magnetized. The magnetically “hard” material tend to stay magnetized. Thus, the second layer can be realized as permanent magnet or can be free of a permanent magnet. The ferromagnetic material is e.g. steel.

In an embodiment of the switching device, the sandwich structure comprises a third layer made of a non-ferromagnetic material. The third and the first layer are made of the same material or of different materials. In an example, the first, the second and the third layer form one piece. Advantageously, the third layer protects the second layer against corrosion. The second layer is fixated between the first layer and the second layer.

In an example, the sandwich structure is fabricated by arranging the first, the second and the third layer on top of each other and by fixating the three layers by a heating and pressing process. The first and the second terminal contacts are realized by cutting the sandwich structure in stripes and by bending the stripes. The first terminal contact is e.g. produced in one piece. The second terminal contact is e.g. produced in one piece.

In an embodiment of the switching device, the first fixed contact is located on the first layer of the first terminal contact. The second fixed contact is located on the first layer of the second terminal contact. The first and the second fixed contacts are made e.g. of silver or a silver alloy. Advantageously, the material of the first and the second fixed contacts is configured to have a good electrical and good mechanical connection to the non-ferromagnetic material of the first layer.

In an embodiment of the switching device, the first and the second movable contacts are made of silver or a silver alloy.

In an embodiment of the switching device, the first terminal contact has a terminal thickness DT. The first layer has a first thickness D1 following the equation:

$$46 \% DT \leq D 1 \leq 60 \% DT .$$

In an embodiment of the switching device, the second layer has a second thickness D2 and the third layer has a third thickness D3 following the equations:

$$1 \% DT \leq D 3 \leq 10 \% DT and D 2 = DT - D 1 - D 3.$$

In an embodiment of the switching device, the terminal thickness DT is in a range between 0.8 mm and 2.5 mm or in a range between 1.0 mm and 2.0 mm.

In an embodiment of the switching device, the contact bridge has an extension DB. An outer edge of the first movable contact has a distance DE to an outer edge of the second movable contact. The extension DB follows the equation:

$$DE + 5 mm < DB < DE + 20 mm or DE + 7 mm < DB < DE + 18 mm$$

In an embodiment of the switching device, both ends of the contact bridge are bended in a direction away from the first and the second terminal contact. Thus, a length of the first arc is increased, when the first arc moves to the first arc horn.

In an embodiment of the switching device, the contact bridge is bended such that the contact bridge has the form of a first arc horn near the first movable contact and of a second arc horn near the second movable contact.

In an embodiment, the slot motor is realized as electromagnetic slot motor.

In an embodiment of the switching device, the first motor part comprises two plates and the second motor part comprises two further plates. In an example, the plates and the further two plates are made of ferromagnetic material, e.g. steel.

In an embodiment, the switching device comprises an arc deflector. The arc deflector is made e.g. of copper. The arc deflector is e.g. made of one piece.

In an embodiment, the switching device comprises a first arc extinguishing device. The switching device also comprises a second arc extinguishing device.

In an embodiment of the switching device, the arc deflector is arranged near the first arc extinguishing device, the contact bridge and the second arc extinguishing device. Thus, the arc deflector and a part of the first terminal contact guide the first arc towards the first arc extinguishing device.

In an embodiment, the switching device comprises a magnetic drive assembly with an electric coil, a magnetic core and an armature. The armature is movable and is coupled to the contact bridge e.g. via a contact bridge carrier of the switching device.

In an embodiment of the switching device, the first terminal contact comprises a U-form and the second terminal contact comprises a U-form.

In an embodiment of the switching device, the U-form of the first terminal contact has a first arm, a second arm and a bended part connecting the first arm to the second arm. The first fixed contact is located at the first arm of the U-form of the first terminal contact.

In an embodiment, the switching device is implemented as motor protective switching device (abbreviated MPSD). A MPSD can be named e.g. motor protection circuit breaker (abbreviated MPCB).

In an alternative embodiment, the switching device is implemented as moulded case circuit breaker (abbreviated MCCB).

In an example, the switching device is configured as improved current limiting low voltage circuit breaker. To improve the overall performance of the circuit breaker during high current (e.g. at short-circuit) and medium current (inductive load inrush current), current limiting features are advantageous. Current limiting features are achieved e.g. with various arrangements such as reverse loop contacts, electromagnetic coil relay etc. Current limiting mainly helps to limit the total arc energy and to limit thermodynamic stresses imparted on the system and the circuit breaker. In case of low voltage circuit breaker development, it is advantageous to reduce manufacturing cost along with a simplification of the various manufacturing and assembly processes. Further enhancement of existing features, functionality and operational efficiency is also advantageous. The switching device has an improved contact system and mechanism.

In an example, arc energy reduction is critical for electrical safety in a workplace. The added feature of the circuit breaker can reduce e.g. arc-flash injuries by lowering fault clearing times. In an example, the clearing time is reduced by a combined effect of one or more than one improvements in the design. The improvements result in a considerable reduction of the arcing time. Moreover, there is a considerable reduction in contact and other metal erosion and globule formation. Less globule formation avoids mechanism malfunctioning and also splitter plates do not get shorted due to stuck or trapped globules within them. The combined effect of several design improvements helps in increasing the magnetic pull out force approximately e.g. by 20% to 30% in comparison to a conventional design of the switching device. This design improves the breaker performance and its short circuit rating. In tests, the observed arcing time is reduced drastically, e.g. by 60% to 70%.

The following description of figures of embodiments may further illustrate and explain aspects of the switching device. Parts and devices with the same structure and the same effect, respectively, appear with equivalent reference symbols. In so far as parts or devices correspond to one another in terms of their function in different figures, the description thereof is not repeated for each of the following figures.

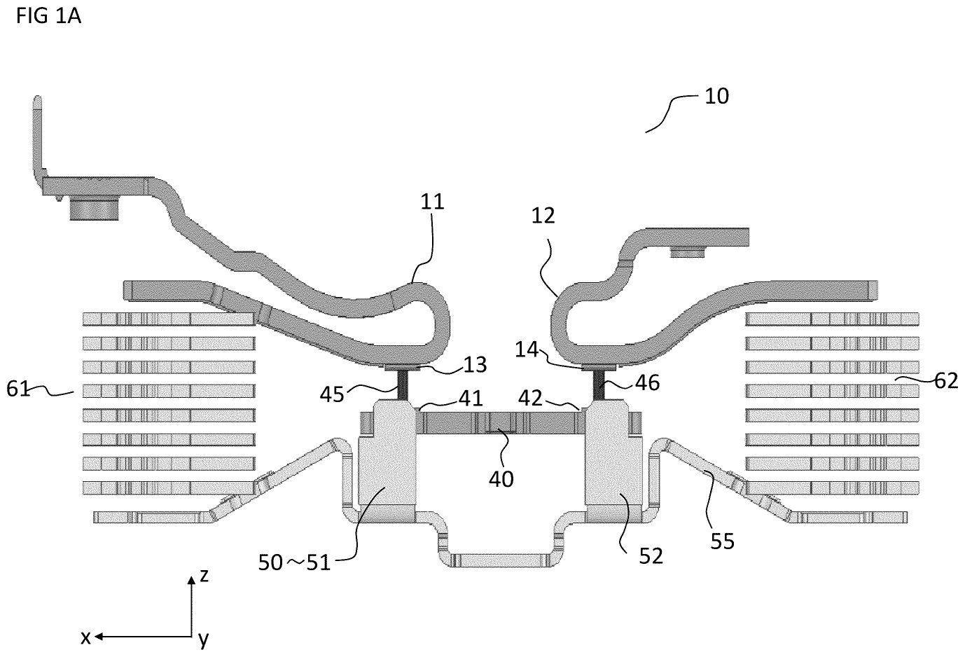

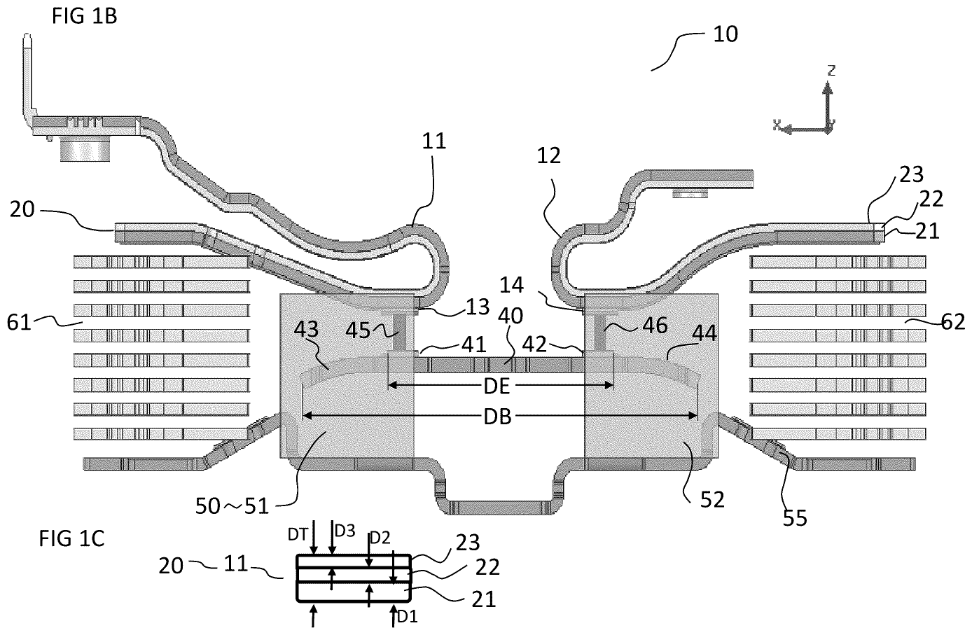

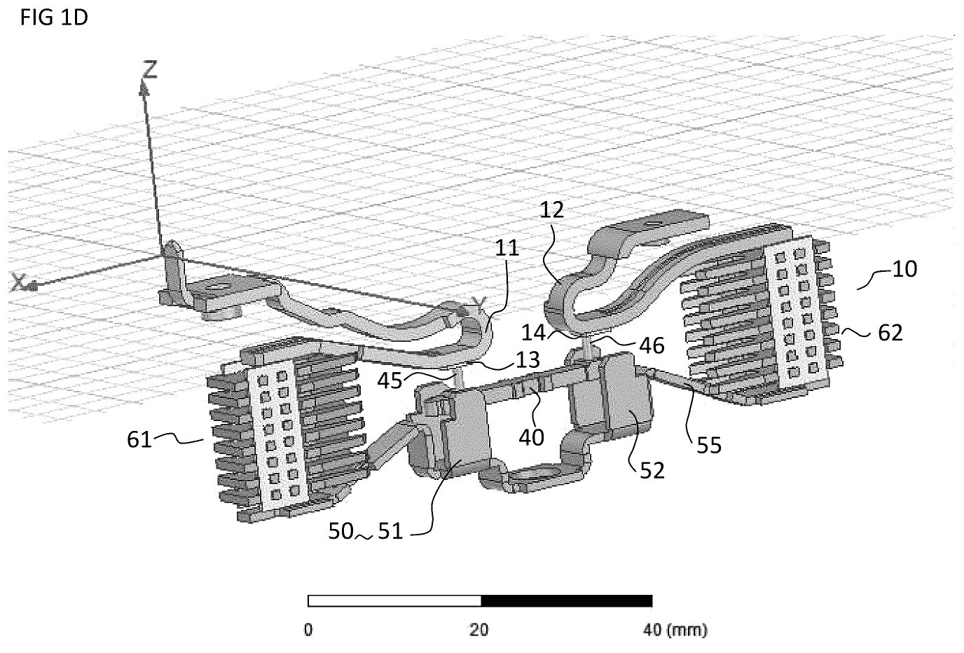

FIGS. 1A to 1D show examples of a switching device;

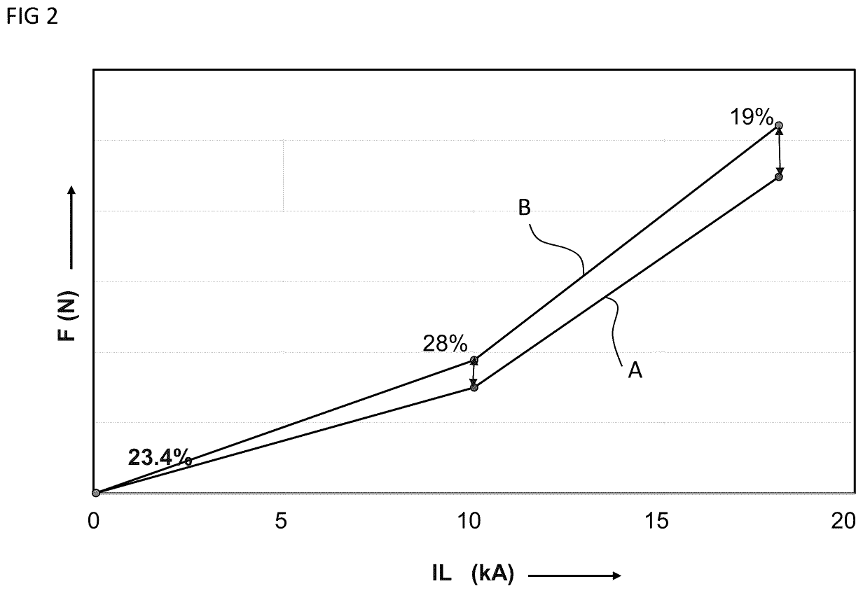

FIG. 2 shows characteristics of different examples of a switching device; and

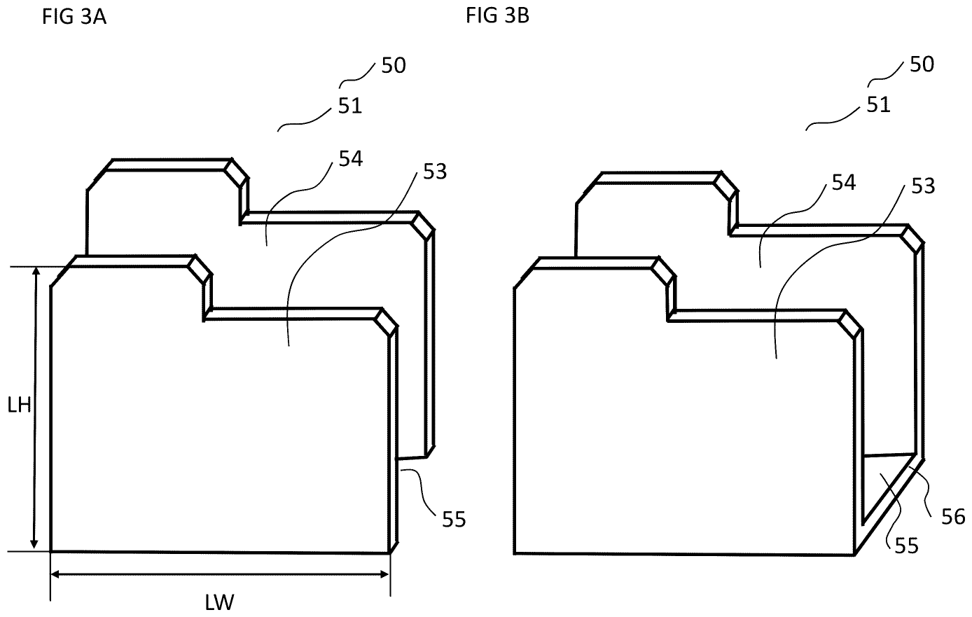

FIGS. 3A and 3B show a slot motor of a switching device.

FIG. 1A shows an example of a switching device 10. The switching device 10 comprises a first and a second terminal contact 11, 12, a first fixed contact 13 arranged at the first terminal contact 11, a second fixed contact 14 arranged at the second terminal contact 12, a contact bridge 40 and a first and a second movable contact 41, 42 arranged at the contact bridge 40. The first and the second terminal contact 11, 12 can be named first and second stationary contact. The first terminal contact 11 and the second terminal contact 12 are made of a non-ferromagnetic material that is e.g. copper or an alloy of copper. The switching device 10 is configured to conduct and switch bidirectional or unidirectional AC currents. Alternatively, the switching device 10 is configured to conduct and switch bidirectional or unidirectional DC currents. The switching device 10 is configured as circuit breaker, e.g. as low voltage circuit breaker. Low voltage can be a voltage less than e.g. 1000 VAC/1500 VDC.

The switching device 10 comprises a slot motor 50 which is realized as electromagnetic slot motor. The slot motor 50 has a first and a second motor part 51, 52. The first and the second motor part 51, 52 both comprise two plates configured to enhance a magnetic field at the different positions of the first and the second arc.

The switching device 10 comprises an arc deflector 55 that is made of a metal. The arc deflector 55 is made e.g. of ferromagnetic steel to have a better arc running from the contact regions to an arc chamber region. The arc deflector 55 is a one-piece arc deflector. The switching device 10 comprises a first and a second arc extinguishing device 61, 62. The arc deflector 55 is arranged near the first arc extinguishing device 61 and the contact bridge 40. The arc deflector 55 is configured to guide a first arc 45 from the contact bridge 40 to the first arc extinguishing device 61. Similarly, the arc deflector 55 is arranged near the second arc extinguishing device 62 and the contact bridge 40. The arc deflector 55 is configured to guide a second arc 46 from the contact bridge 40 to the second arc extinguishing device 62.

The first and the second arc extinguishing device 61, 62 comprise splitter plates. The first and the second arc extinguishing device 61, 62 can be named first and second arc chamber. The first arc extinguishing device 21 is configured to extinguish the first arc 45 generated between the first fixed contact 12 and the first movable contact 14. The second arc extinguishing device 21 is configured to extinguish the second arc 46 generated between the second fixed contact 12 and the second movable contact 14.

The switching device 10 comprises a magnetic drive assembly (not shown) with an electric coil, a magnetic core and an armature. The armature is movable and is coupled to the contact bridge 40, e.g. via a contact bridge carrier of the switching device 10 and via a contact spring of the switching device 10. The arc deflector 55 has a form which provides space for the realization e.g. of the contact bridge carrier and/or of the contact spring. The contact spring is e.g. between the contact bridge carrier and the contact bridge 40 or between the contact bridge carrier and the armature.

The first terminal contact 11 comprises a U-form. The U-form of the first terminal contact 11 has a first arm, a second arm and a bended part connecting the first arm to the second arm. The first fixed contact 13 is located at the first arm of the U-form of the first terminal contact 11. The second terminal contact 12 comprises a U-form. The U-form of the second terminal contact 11 has a first arm, a second arm and a bended part connecting the first arm to the second arm. The second fixed contact 14 is located at the first arm of the U-form of the second terminal contact 12.

The first terminal contact 11 has a bended form such that a load current IL that flows through the first terminal contact 11, the first fixed contact 13, the first movable contact 41 and the contact bridge 40 has a U-formed path in the switched-on state. The first terminal contact 11 forms a first arm of the U-formed path. The contact bridge 40 forms a second arm of the U-formed path. The first movable contact 41 and the first fixed contact 13 are part of the coupling of the first arm to the second arm. The first arc 45 is generated between the first fixed contact 13 and the first movable contact 41 at a transition between a switched-on state and a switched-off state of the switching device 10. The load current IL that flows through the first terminal contact 11, the first fixed contact 13, the first arc 45, the first movable contact 41 and the contact bridge 40 has a U-form. This U-form path of the load current IL results in a force that drives the first arc 45 towards the first arc extinguishing device 61.

Correspondingly, the second terminal contact 12 has a bended form such that the load current IL that flows through the contact bridge 40, the second movable contact 42, the second fixed contact 14 and the second terminal contact 12 has a U-formed path in the switched-on state. The contact bridge 40 forms a first arm of the U-formed path. The second terminal contact 12 forms a second arm of the U-formed path. The second movable contact 42 and the second fixed contact 14 are part of the coupling of the first arm to the second arm. This U-form path of the load current IL results in a force that drives the second arc 46 towards the second arc extinguishing device 62.

In FIG. 1A, the material of the first and the second terminal contact 11, 12 and of the contact bridge 40 is e.g. copper or a copper alloy to provide a low resistance for the current carrying path. The material of the first and the second fixed contact 13, 14 and of the first and the second movable contact 41, 42 is silver or a silver alloy.

FIG. 1B shows an example of a switching device 10 which is a further development of the example shown in FIG. 1A. The first terminal contact 11 and the second terminal contact 12 comprise a sandwich structure 20 of at least a first and a second layer 21, 22 (which is shown in FIG. 1C below FIG. 1B). The first layer 21 is made of a non-ferromagnetic material and the second layer 22 is made of a ferromagnetic material. The non-ferromagnetic material is copper or an alloy of copper. The ferromagnetic material is one of a group consisting of iron, nickel, cobalt, an alloy of iron, nickel or cobalt and an alloy of a rare-earth metal. Optionally, the sandwich structure 20 comprises a third layer 23 made of a non-ferromagnetic material. The second layer 22 is arranged between the first and the third layer 21, 23.

Both ends of the contact bridge 40 are bended in a direction away from the first and the second terminal contact 11, 12. The contact bridge 40 is bended such that the contact bridge 40 has the form of a first arc horn 43 near the first movable contact 41 and of a second arc horn 44 near the second movable contact 41. The contact bridge 40 is extended to realize the first and the second arc horn 43, 44. The contact bridge 40 has an extension DB. An outer edge of the first movable contact 41 has a distance DE to an outer edge of the second movable contact 41. The extension DB follows e.g. one of the equations:

$$DE < DB or DE + 5 mm < DB < DE + 20 mm or DE + 7 mm < DB < DE + 18 mm$$

The first motor part 51 of the slot motor 50 is configured to provide a magnetic field at the first fixed contact 13 and at the first movable contact 41, when the first movable contact 41 is in contact to the first fixed contact 13 and additionally when the first movable contact 41 is in a maximum distance to the first fixed contact 13. The first motor part 51 is configured to provide a magnetic field at the first fixed contact 13 and at the first movable contact 41 during a movement of the first movable contact 41 over a clearing distance. The clearing distance is the distance of a movement of the contact bridge 40 from an on-position of the contact bridge 40 in a switched-on state of the switching device 10 to an off-position of the contact bridge 40 in a switched-off state of the switching device 10, e.g. in the absence of a short circuit. The duration of the movement of the contact bridge 40 from the on-position of the contact bridge 40 to the off-position of the contact bridge 40 is named clearing time.

Correspondingly, the second motor part 52 of the slot motor 50 is configured to provide a magnetic field at the second fixed contact 14 and at the second movable contact 42, when the second movable contact 42 is in contact to the second fixed contact 14 and additionally when the second movable contact 42 is in a maximum distance to the second fixed contact 14. The second motor part 52 is configured to provide a magnetic field at the second fixed contact 14 and at the second movable contact 42 during a movement of the second movable contact 42 over the clearing distance.

The arc deflector 55 is made of copper or copper alloy. Advantageously, copper allows a faster movement of the first and the second arc in comparison to iron or steel, due to the different surface structures of copper and ion or steel.

To improve magnetic field and the arc pull out force on the first and the second arc 45, 46, a ferromagnetic component or several ferromagnetic components are located in the vicinity of moving and stationary contacts. The locations of the ferromagnetic plate or plates and its overall size has been optimized by an electromagnetic simulation, abbreviated EMAG simulation. In case of due space constraints, arc plate side arms and legs cannot be extended to make as close as possible to the contact system. Here an extension of the slot motor 50 can provide the generation or creation of a high magnetic field around the arcs 45, 46.

A contact system of the switching device 10 comprises U-shaped terminal contacts 11, 12. In general, the contact material is copper to have a minimum resistance across the terminals. However, to improve magnetic field generation and to reduce arc immobility and arc running time, the sandwich structure 20 helps to a great extent. The sandwich structure 20 is implemented e.g. by a tri-layered composition or three layer composition, for example Cu—Fe—Cu.

The first arc horn 43 and the arc deflector 55 are designed such that one pole or one end of the first arc 45 runs from the first movable contact 41 via the first arc horn 43 to the arc deflector 55. Correspondingly, the second arc horn 44 and the arc deflector 55 are designed such that one pole or one end of the second arc 46 runs from the second movable contact 42 via the second arc horn 44 to the arc deflector 55. Thus, in case of a contact opening e.g. in a short circuit condition, the load current IL flows from the first contact terminal 11 via the first arc 45, the arc deflector 55 and the second arc 46 to the second contact terminal 12. Advantageously, the arc deflector 55 has a low resistance from one end to the other end of the arc deflector 55. In an example, in case of a short-circuit, the first and the second arc horn 43, 44 have a mechanical contact to the arc deflector 55 or only a small gap to the arc deflector 55. The extended arc horns 43, 44 of the contact bridge 40 also help to reduce arcing time by providing an easy transition of the arc column from the contact area to the arc chamber. However, an increased weight of the contact bridge 40 may e.g. impact contact opening acceleration.

Circuit breaker performance is not only important at high current during short circuit fault, but also during lower current such as overload, inrush or critical current. At lower current levels, the magnetic field generation around the contact system is also low. So the arc chambers 61, 62 cannot pull out the arcs 45, 46 away from to contact tips as fast as possible. Thus, arc mobility is reduced and arc running time increases. This results in heavy erosion of the silver alloy contact tips. This leads to a failure of the switching device 10 in the form of loss of continuity or high contact resistance and of temperature rise across the terminals. To verify breaker performance and total arcing time, electromagnetic simulation along with tests were performed.

The function of the switching device 10 is to protect an end application or equipment from short-circuit and overload conditions. During overload condition—for example lower current levels—the arc chamber is unable to exert a desired force on the arcs 45, 46 and the arcs 45, 46 stay on the contact tips which leads to extensive erosion of contact tips. This leads to failure of the switching device 10 and to damage of end equipment. To improve the circuit breaker performance, reducing the arcing time is advantageous. This approach helps to improve short circuit ratings of products. The amendments are realized using a constrained space, e.g. in the footprint of present products. So instead of designing new frames of new products from scratch, this approach of redesigning gives an added value to present products. Apart from this, such design solutions of the switching device 10 are very cost-effective in comparison to conventional hybrid and solid-state breaker technologies.

The ferromagnetic slot motor 50 which can also be named blow-out coil is generally placed near the fixed contacts 13, 14 and the movable contacts 41, 42. The slot motor 50 is free of a coil. The slot motor 50 is free of a conduction line. The name blow-out coil results from a U-form of the load current IL that flows through the first terminal contact 11, the first fixed contact 13, the first arc 45 (if the first arc 45 exists), the first movable contact 41 and the contact bridge 40. The slot motor 50 strengthens the magnetic field in the contact region and on the arcs 45, 46. So the movement of the arcs 45, 46 towards the arc chamber assembly is improved. As a part of an experimental DoE (DoE stands for design of experiment) with electromagnetic simulation and laboratory tests, various designs and material combinations were verified.

To reduce the total arcing time, the arc deflector 55 made of copper is more effective compared to the arc deflector 55 made of steel. The profile and the ramp of the arc deflector 55 is designed to provide a smooth transition of the arc root from the arc horns 43, 44 to the elevated portion of the arc deflector 55. Furthermore, the arc chamber pulls the arcs 45, 46 towards it and the arcs 45, 46 can easily enter into the splitter plates. Tests performed in the laboratory also support this in terms of a considerable reduction of the arcing time.

The location of the slot motor 50, its profile and overall size plays a key role. Specific to this circuit breaker design, the width of the slot motor 50 is optimized to cover a maximum area from the main contacts 13, 14, 41, 42 to the splitter plates of the first and the second arc extinguishing device 61, 62. So this plate exerts consistent magnetic pull-out force on the arc column throughout the travelling distance of the arcs 45, 46. So the arc running time decreases drastically. The height of the slot motor 50 is configured such that it covers the complete gap of contact opening. Thus, the pull out is being exerted along the complete height of the arc column. The force on the arcs 45, 46 is increased by significant amount by the 3-layered contact material that realize the sandwich structure 20. The 3-layered terminal contacts 11, 12 —Cu—Fe—Cu— are used instead of terminal contacts 11, 12 made only of copper. The steel part in the terminal contacts 11, 12 exerts force on the arcs 45, 46 and improves an initial acceleration of the arcs 45, 46. The percentage of the three layers 21 to 23 is based on current density and space availability.

The switching device 10 reduces the arcing time by improving arc quenching performance of the contact system and of the arc chamber.

FIG. 1C shows an example of details of a switching device 10 which is a further development of the example shown in FIGS. 1A and 1B. The first terminal contact 11 has a terminal thickness DT. The first layer 21 has a first thickness D1 following the equation:

$$46 \% DT \leq D 1 \leq 60 \% DT .$$

The second layer 22 has a second thickness D2 and the third layer 23 has a third thickness D3 following the equations:

$$1 \% DT \leq D 3 \leq 10 \% DT and D 2 = DT - D 1 - D 3.$$

The first and the third layer 21, 23 e.g. prevent a corrosion of the second layer 22. The first terminal contact 11 and the second terminal contact 12 comprise the same sandwich structure 20.

In an alternative, not shown embodiment, the sandwich structure 20 is free of the third layer 23. In this case, the first and the second thickness D1, D2 follow e.g. the equations:

$$46 \% DT \leq D 1 \leq 60 \% DT .$$

$$D 2 = DT - D 1.$$

FIG. 1D shows an example of a switching device 10 in a three dimensional view which is a further development of the examples shown in FIGS. 1A and 1B.

A considerable reduction in total arcing time, for example from 8-9 ms to 1.6-1.8 ms is achieved. This leads to minimum thermodynamic stress on the system and less contact erosion. The circuit breaker is able e.g. to pass short circuit and make break requirements.

FIG. 2 shows characteristics of different examples of a switching device 10 such as realized e.g. as shown in FIGS. 1A to 1D. A force F (given in artificial units) as a function of the load current IL (in kA) is shown. The force F is the force in the x-direction on the first or the second arc 45, 46 (the x-direction is indicated in FIGS. 1A, 1B and 1D). The arcs 45, 46 are in the form of an arc column. The vales of the force F are calculated. The curve achieved with a switching device 10 as shown in FIG. 1A is marked with A and the curve achieved with a switching device 10 as shown in FIG. 1B is marked with B.

FIG. 3A shows a slot motor 50 of a switching device 10 which is a further development of the examples shown in FIGS. 1A to 1D and 2. The slot motor 50 comprises the first motor part 51. The second motor part 52 (not shown) of the slot motor 50 is realized similar to the first motor part 51 (e.g. mirrored at a vertical axis). The first motor part 51 comprises a first and a second plate 53, 54. The first and the second plate 53, 54 are made of ferromagnetic material, e.g. steel. The first plate 53 is positioned in a distance to the second plate 54. Thus, the slot motor 50 comprises a slot 56. The slot 56 is between the first and the second plate 53, 54. The first motor part 51 is configured to provide a magnetic field at the first fixed contact 13 and at the first movable contact 41 in case the first movable contact 41 is in contact to the first fixed contact 13 and in case the first movable contact 41 is in a maximum distance to the first fixed contact 13.

The first motor part 51 is designed that the contact bridge 40 can move inside the slot 56. Also the first fixed contact 13 and a part of the first terminal contact 11 are located in the slot 56.

The slot motor 50 is realized as electromagnetic slot motor. Thus, the slot motor 50 is free of a permanent magnet. The slot motor 50 is free of a coil. The load current IL flows through the first terminal contact 11, the first fixed contact 13, the first arc 45, the first movable contact 41 and the contact bridge 40. According to Ampere's law or Biot-Savart's law, a magnetic field is generated by the load current IL. Since the first terminal contact 11, the first fixed contact 13, the first arc 45, the first movable contact 41 and the contact bridge 40 have a U-form, the load current IL also has a U-form. Thus, the magnetic field inside the U-form is larger than outside of the U-form. Therefore, the first arc 45 is driven away from the first fixed contact 13 and the first movable contact 41 in the direction of the first arc extinguishing device 61. Advantageously, the load current IL generates a magnetic field that is concentrated by the first motor part 51 on the first arc 45.

The slot motor 50 is configured to provide a magnetic field to the first arc 45 during the run or travel of the first arc 45 from the first fixed contact 13 and the first movable contact 41 to the first arc extinguishing device 61. Thus, the slot motor 50 is configured to provide a magnetic field to the first arc 45 between a part of the first terminal contact 11 and the first arc horn 43. Moreover, the slot motor 50 is configured to provide a magnetic field to the first arc 45 between a part of the first terminal contact 11 and a part of the arc deflector 55.

The first plate 53 of the first motor part 51 has a maximum width LW in a direction from the first fixed contact 13 and the first movable contact 41 towards the first arc extinguishing device 61. The maximum width LW follows the equations:

$$9 mm \leq LW \leq 18 mm or 11 mm \leq LW \leq 16 mm$$

The first plate 53 of the first motor part 51 has a maximum height LH in a direction perpendicular to the direction of the maximum width LW of the first fixed contact 13 and the first movable contact 41 towards the first arc extinguishing device 61. The maximum height LH follows the equations:

$$6 mm \leq LH \leq 15 mm or 8 mm \leq LH \leq 13 mm$$

A thickness of the first plate 53 is in a range between 0.5 mm and 4 mm, e.g. 1 mm.

The second motor part 52 (not shown in FIG. 3A) comprises two further plates. The two further plates are realized such as the first and the second plate 53, 54. The second motor part 52 operates such as the first motor part 51.

FIG. 3B shows a slot motor 50 of a switching device 10 which is a further development of the examples shown in FIGS. 1A to 1D, 2 and 3A. The first motor part 51 comprises a connector 57 that connects the first plate 53 to the second plate 54. Thus, the magnetic field and the stability of the slot motor 50 is increased; however, the connector 57 consumes space in the switching device 10.

The embodiments shown in FIGS. 1A to 1D, 2, 3A and 3B as stated represent examples of the improved switching device 10; therefore, they do not constitute a complete list of all embodiments according to the improved switching device. Actual switching devices may vary from the embodiments shown in terms of parts, structures, materials and shape, for example.

### REFERENCE NUMERALS

10 switching device
11, 12 terminal contact
13, 14 fixed contact
20 sandwich structure
21 to 23 layer
40 contact bridge
41, 42 movable contact
43, 44 arc horn
45, 46 arc
50 slot motor
51, 52 motor part
53, 54 plate
55 arc deflector
56 slot
57 connector
61, 62 arc extinguishing device
DB extension
DE distance
DT terminal thickness
D1-D3 thickness
F force
IL load current
LH height
LW width

1. A switching device, comprising
a first and a second terminal contact,
a first fixed contact arranged at the first terminal contact,
a second fixed contact arranged at the second terminal contact,
a slot motor comprising a first and a second motor part,
a contact bridge, and
a first and a second movable contact arranged at the contact bridge,
wherein the first terminal contact and the second terminal contact comprise a sandwich structure of at least a first and a second layer,
wherein the first layer is made of a non-ferromagnetic material and the second layer is made of a ferromagnetic material,
wherein the first motor part is configured to provide a magnetic field at the first fixed contact and at the first movable contact in case the first movable contact is in contact to the first fixed contact and in case the first movable contact is in a maximum distance to the first fixed contact, and
wherein the second motor part is configured to provide a magnetic field at the second fixed contact and at the second movable contact in case the second movable contact is in contact to the second fixed contact and in case the second movable contact is in a maximum distance to the second fixed contact.

2. The switching device according to claim 1,
wherein the non-ferromagnetic material is copper or an alloy of copper.

3. The switching device according to claim 1,
wherein the ferromagnetic material is one of a group consisting of iron, nickel, cobalt, an alloy of iron, nickel or cobalt and an alloy of a rare-earth metal.

4. The switching device according to claim 1,
wherein the sandwich structure comprises a third layer made of a non-ferromagnetic material.

5. The switching device according to claim 4,
wherein the first terminal contact has a terminal thickness DT and the first layer has a first thickness D1 following the equation:
$$46 \% DT \leq D 1 \leq 60 \% DT .$$

6. The switching device according to claim 5,
wherein the second layer has a second thickness D2 and the third layer has a third thickness D3 following the equations:
$$1 \% DT \leq D 3 \leq 10 \% DT and D 2 = DT - D 1 - D 3.$$

7. The switching device according to claim 1,
wherein the contact bridge has an extension DB and an outer edge of the first movable contact has a distance DE to an outer edge of the second movable contact following the equation:
$$DE + 5 mm < DB < DE + 20 mm .$$

8. The switching device according to claim 1,
wherein both ends of the contact bridge are bended in a direction away from the first and the second terminal contact.

9. The switching device according to claim 1,
wherein the contact bridge is bended such that the contact bridge has the form of a first arc horn near the first movable contact and of a second arc horn near the second movable contact.

10. The switching device according to claim 1,
wherein the slot motor is realized as electromagnetic slot motor.

11. The switching device according to claim 1,
wherein the first motor part comprises two plates made of ferromagnetic material and the second motor part comprises two further plates made of ferromagnetic material.

12. The switching device according to claim 1,
wherein the switching device comprises an arc deflector that is made of copper.

13. The switching device according to claim 12,
wherein the switching device comprises a first and a second arc extinguishing device, and
wherein the arc deflector is arranged near the first arc extinguishing device, the contact bridge and the second arc extinguishing device.

14. The switching device according to claim 1,
wherein first terminal contact comprises a U-form and the second terminal contact comprises a U-form.

15. The switching device according to claim 1,
wherein the switching device is implemented as motor protective switching device.
